(19) United States
(12) Patent Application Publication
(10) Pub. No.: US 2026/0312147 A1
(43) Pub. Date: Oct. 8, 2026

(54) PRESSING APPARATUS FOR MANUFACTURING SECONDARY BATTERY

(71) Applicant: Samsung SDI Co., Ltd., Yongin-si (KR)

(72) Inventor: Hyeonseo Song, Yongin-si (KR)

(73) Assignee: Samsung SDI Co., Ltd., Yongin-si (KR)

(21) Appl. No.: 19/634,598

(22) Filed: Mar. 31, 2026

(30) Foreign Application Priority Data
Apr. 2, 2025 (KR) 10-2025-0042970

(51) Int. Cl. H01M 10/0587

(52) U.S. Cl. CPC H01M 10/0587

(57) ABSTRACT

Disclosed is a pressing apparatus for manufacturing a secondary battery. The pressing apparatus may include a pressing plate, and a pressing pad secured to a pressing surface of the pressing plate, and including a three-dimensional lattice structure provided by repeatedly or regularly arranging unit cells each formed by connecting struts.

### CROSS-REFERENCE TO RELATED APPLICATION

This present application claims priority to and the benefit under 35 U.S.C. § 119(a)-(d) of Korean Patent Application No. 10-2025-0042970, filed on Apr. 2, 2025, in the Korean Intellectual Property Office, the entire disclosure of which is incorporated herein by reference.

### FIELD

The present disclosure relates to a pressing apparatus for manufacturing a secondary battery.

### BACKGROUND

Unlike primary batteries that are not designed to be charged, secondary batteries are designed to be discharged and recharged. Low-capacity secondary batteries are used in small portable electronic devices, such as smart phones, feature phones, notebook computers, digital cameras, and camcorders, while large-capacity secondary batteries are widely used as power sources for driving motors, such as of hybrid vehicles or electric vehicles, and for power storage. The secondary battery includes an electrode assembly consisting of a positive electrode and a negative electrode, a case that accommodates the electrode assembly, terminal part connected to the electrode assembly, etc.

Secondary batteries have advantages such as high energy density, discharge voltage, and output stability, and thus there is a high demand for the secondary batteries. A process of manufacturing a secondary battery may be roughly divided into an electrode plate process, a winding process, an assembly process, and a formation process. The formation process includes a heater press charge (HPC) process of activating a battery by heating, pressing, and charging battery cells. When pressing the battery cells during the HPC process, it is important to apply pressure to the battery cells uniformly. However, there is a problem in that it is difficult to apply uniform pressure to the battery cells due to a difference in flatness between electrode assemblies included in the battery cells depending on the structure of each electrode assembly.

The above information disclosed in this Background section is for enhancement of understanding of the background of the present disclosure, and therefore, it may contain information that does not constitute related (or prior) art.

### SUMMARY

Embodiments Of the present disclosure are directed to providing a pressing apparatus for manufacturing a secondary battery, in which a pressing component having a three dimensional lattice structure is formed on a pressing surface of a pressing plate.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

A pressing apparatus for manufacturing a secondary battery according to embodiments of the present disclosure may include: a pressing plate; and a pressing pad secured to a pressing surface of the pressing plate, and including a three-dimensional lattice structure provided by repeatedly or regularly arranging unit cells each formed by connecting struts.

In embodiments, the lattice structure may include at least one layer including the plurality of unit cells arranged in a column direction and a row direction, and may include a first area and a second area extending from the first area, the first area and the second area being defined in a direction intersecting with a pressing direction.

In embodiments, a density of the unit cells assigned to the second area may be higher than a density of the unit cells assigned to the first area.

In embodiments, a size of each of the unit cells assigned to the second area may be less than a size of each of the unit cells assigned to the first area.

In embodiments, the at least one layer may include a plurality of sub-layers divided along the pressing direction in correspondence with the second area. The at least one layer in the first area may include a first unit cell. Each of the sub-layers in the second area may include a second unit cell. A size of the second unit cell may be less than a size of the first unit cell.

In embodiments, the first unit cell and the second unit cell may be configured as respective unit cells having a same structure.

In embodiments, a porosity of the unit cells assigned to the second area may be set lower than a porosity of the unit cells assigned to the first area.

In embodiments, a thickness of each of the struts that form the unit cells assigned to the second area may be set greater than a thickness of each of the struts that form the unit cells assigned to the first area.

In embodiments, the unit cells may include a first unit cell assigned to the first area, and a second unit cell assigned to the second area. The second unit cell may have a structure different from a structure of the first unit cell.

In embodiments, the second unit cell may be selected as a structure having a higher stiffness or lower strain than a stiffness or strain of a structure of the first unit cell.

In embodiments, the second unit cell may be selected as one of an octet truss, Kagome, diamond cell, or face-centered cubic (FCC). The first unit cell may be selected as one of a Kelvin cell, tetrahedral cell, or dodecahedron.

In embodiments, the second unit cell may be selected as one of unit cells having a stretching-dominant structure. The first unit cell may be selected as one of unit cells having a bending-dominant structure.

In embodiments, the second area may have a greater thickness than a thickness of the first area.

In embodiments, the second area may further include an additional layer stacked on the at least one layer along the pressing direction, the additional layer including a plurality of unit cells arranged in the column direction and the row direction.

In embodiments, the pressing pad may include a first plate including a fixing surface fixed to the pressing surface of the pressing plate, and a connection surface fixed to one surface of the lattice structure.

In embodiments, the pressing pad may include a second plate disposed to face the first plate along the pressing direction with the lattice structure interposed therebetween, the second plate including a connection surface fixed to another surface of the lattice structure.

In embodiments, the first plate and the second plate may be integrally formed with the lattice structure.

In embodiments, the first plate and the second plate may be formed of a same material as a material of the lattice structure.

In embodiment. s, the pressing pad may be formed of thermoplastic polyurethane (TPU).

In embodiments, each of the unit cells may be selected as one of unit cells having a stretching-dominant lattice structure.

According to embodiments of the present disclosure, a pressing pad including a three-dimensional lattice structure may be used to press a battery cell, thus improving pressing uniformity with respect to the battery cell.

Particularly, according to embodiments of the present disclosure, different pressing forces may be provided to different areas, so that a relatively uniform pressing force may be applied even to an electrode assembly having a thickness deviation depending on position. Accordingly, it is possible to prevent detachment of a separator due to separation of adhesion caused by the thickness deviation of the electrode assembly, thereby securing reliability and stability of the product.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

FIG. 1A is a perspective view illustrating an example of a structure of a pouch-type secondary battery, and FIG. 1B is a perspective view illustrating another example of the structure of the pouch-type secondary battery.

FIG. 2 is a sectional view illustrating an electrode assembly of the pouch-type secondary battery.

FIG. 3 is a view illustrating a thickness deviation according to a position of an electrode assembly.

FIG. 4 is a view illustrating an example of a general heater press charge (HPC) process.

FIG. 5 is a schematic view illustrating a battery cell pressing apparatus according to embodiments of the present disclosure.

FIG. 6 is a schematic view illustrating a pressing pad according to embodiments of the present disclosure.

FIG. 7 is a view illustrating an example of a unit cell that forms the pressing pad according to embodiments of the present disclosure.

FIG. 8 is a schematic sectional view illustrating a lattice structure according to embodiments of the present disclosure.

FIG. 9 is a schematic sectional view illustrating a pressing pad according to embodiments of the present disclosure.

FIG. 10 is a schematic sectional view illustrating a pressing pad according to embodiments of the present disclosure.

FIG. 11 is a schematic sectional view illustrating a pressing pad according to embodiments of the present disclosure.

### DETAILED DESCRIPTION

Exemplary embodiments of the present disclosure will be described below in detail with reference to the accompanying drawings. Prior to the description, it is noted that the terms or words used in this specification and claims should not be construed as being limited to common or dictionary meanings but instead should be understood to have meanings and concepts in agreement with the spirit of the present disclosure based on the principle that an inventor can define the concept of each term Suitably in order to describe his/her own invention in the best way possible. Accordingly, since the embodiments described in this specification and the configurations illustrated in the drawings are only an example of the present disclosure and they do not cover all the technical ideas of the present disclosure, it should be understood that various changes and modifications may be made at the time of filing this application.

It will be further understood that the terms “comprises/includes” and/or “comprising/including” when used herein, specify the presence of stated features, integers, steps, operations, elements, components, and/or groups thereof, but do not preclude the presence or addition of one or more other features, integers, steps, operations, elements, components, and/or groups thereof.

In order to facilitate understanding of the present disclosure, the accompanying drawings are not drawn to scale and the dimensions of some components may be exaggerated. It should be noted that the same reference numerals are designated to the same components in different embodiments. Reference to two compared elements, features, etc. as being “the same” means that they are “substantially the same”. Therefore, the phrase “substantially the same” may include a deviation that is considered low in the art, for example, a deviation of 5% or less. The uniformity of any parameter in a given region may mean that it is uniform from an average perspective.

Although the terms such as “first” and/or “second” are used to describe various components, these components are not limited by these terms, of course. These terms are only used to distinguish one component from another component. Thus, unless specifically stated to the contrary, a first component may be termed a second component without departing from the teachings of exemplary embodiments.

Throughout the specification, unless otherwise stated, each element may be singular or plural.

Arrangement of any component “above (or below)” or “on (or under)” a component may mean that any component is disposed in contact with the upper (or lower) surface of the component, as well as that other components may be interposed between the element and any element disposed on (or under) the element.

It will be understood that, when a component is referred to as being “connected”, “coupled”, or “joined” to another component, not only can it be directly “connected” , “coupled”, or “joined” to the other element, but also can it be indirectly “connected”, “coupled”, or “joined” to the other element with other elements interposed therebetween. As used herein, the term “and/or” includes any and all combinations of one more of the associate listed items. The use of “may” when describing embodiments of the present disclosure relates to “one or more embodiments of the present disclosure”. Expressions such as “at least one” and “one or more” preceding a list of elements modify the entire list of elements and do not modify the individual elements in the list.

Throughout the specification, when “A and/or B” is stated, it means A, B, or A and B, unless otherwise stated. In addition, when “C to D” is stated, it means C or more and D or less, unless specifically stated to the contrary.

When the phrase such as “at least one of A, B, and C”, “at least one of A, B, or C”, “at least one selected from the group of A, B, and C”, or “at least one selected from among A, B, and C” is used to designate a list of elements A, B, and C, the phrase may refer to any and all suitable combinations.

The term “use” may be considered synonymous with the term “utilize”. As used herein, the terms “substantially,” “about,” and similar terms are used as terms of approximation rather than as terms of degree, and are intended to account for inherent variations in measured or calculated values that would be recognized by those of ordinary skill in the art. It will be understood that, although the terms first, second, third, etc. may be used herein to describe various elements, components, regions, layers, and/or sections, these elements, Components, regions, layers, and/or sections should not be limited by these terms. These terms are used to distinguish one element, component, region, layer, or section from another element, component, region, layer, or section. Accordingly, a first element, component, region, layer, or section discussed below may be termed a second element, component, region, layer, or section without departing from the teachings of exemplary embodiments.

For ease of explanation in describing the relationship of one element or feature to another element(s) or feature(s) as illustrated in the drawings, spatially relative terms such as “beneath”, “below”, “lower”, “above”, and “upper” may be used herein. It will be understood that spatially relative positions are intended to encompass different directions of the device in use or operation in addition to the direction depicted in the drawings. For example, if the device in the drawings is turned over, any element described as being “below” or “beneath” another element would then be oriented “above” or “over” another element. Therefore, the term “below” may encompass both upward and downward directions.

The terminology used herein is for the purpose of describing embodiments of the present disclosure and is not intended to limit the present disclosure.

Examples of secondary batteries include a coin type, a cylindrical type, a prismatic type, and a pouch type. The present disclosure is basically applicable to a pouch type secondary battery. Therefore, the pouch type secondary battery will first be briefly described prior to description of embodiments of the present disclosure.

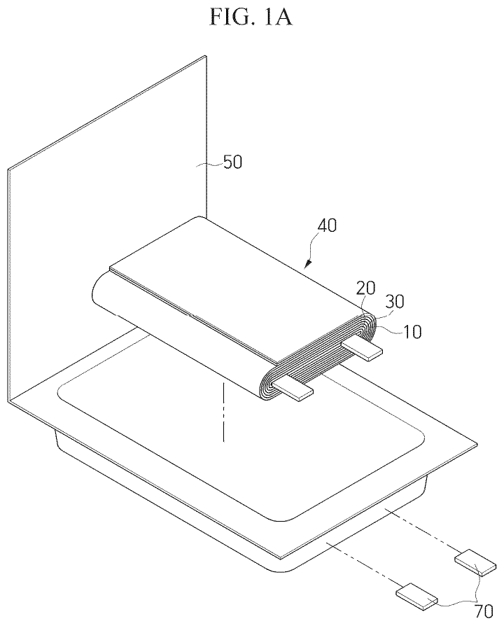

FIG. 1A represents one example of pouch type secondary battery. FIG. 1B represents another example of pouch type secondary battery.

Referring to FIG. 1A and FIG. 1B, a pouch type secondary battery 1 may include an electrode assembly 40 in which a separator 30 has been interposed between a first electrode plate 10 and a second electrode plate 20 and a case 50 in which the electrode assembly 40 has been embedded. The first electrode plate 10, the second electrode plate 20, and the separator 30 may be impregnated in an electrolyte (not illustrated). the pouch type secondary battery 1 may include an electrode tab 70 that plays a role as an electrical passage for inducing a current formed in the electrode assembly 40 toward the outside, that is, a first electrode tab 71 and a second electrode tab 72.

The electrode assembly 40 may be formed by winding OI stacking a stack body including the first electrode plate 10, the second electrode plate 20, and the separator 30 each of which is formed in a plate or film shape. In the case of the winding stack body, the winding axis of the electrode assembly 40 may be parallel to the length direction of the case. Furthermore, the electrode assembly 40 may be the stack type not the winding type, but a shape of the electrode assembly 40 is not limited in an embodiment of the present disclosure. The first electrode plate 10 of the electrode assembly 40 may play a role as a positive electrode, and the second electrode plate 20 thereof may play a role as a negative electrode, and vice versa.

The first electrode plate 10 may be formed by applying a first electrode active material, such as graphite or carbon, to a first electrode collector plate formed of metal foil, such as copper, a copper alloy, nickel, or a nickel alloy, and may include a first electrode tab (or a first uncoated part), that is, an area to which the first electrode active material has not been applied.

The second electrode plate 20 may be formed by applying a second electrode active material, such as transition metal oxide, to a material formed of metal foil, such as aluminum or an aluminum alloy, and may include a second electrode tab (or a second uncoated part), that is, an area to which the second electrode active material has not been applied.

The separator 30 may function to prevent a short-circuit between the first electrode plate 10 and the second electrode plate 20 while permitting a movement of lithium ions. The separator 30 may be composed of a polyethylene film, a polypropylene film, or a polyethylene-polypropylene film, for example.

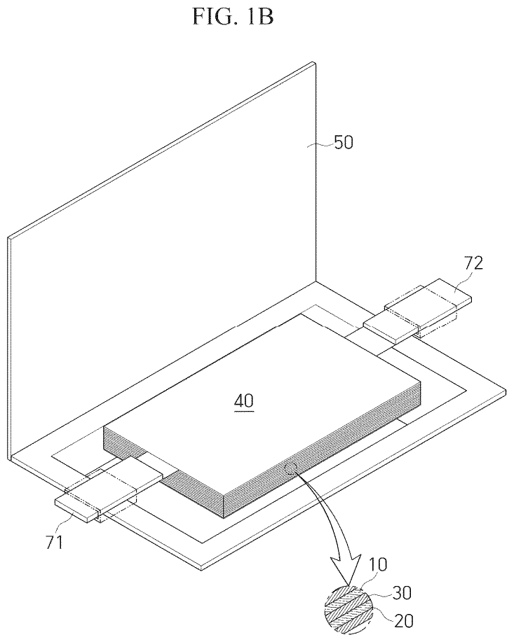

The case 50 may be composed of a laminate film or a plastic, as a pouch type. The case 50 is sealed by the sealing portions at the edges contacting each other while accommodating the electrode assembly 40. In this case, the sealing is performed with the electrode tab 70, or the positive electrode tab 71 and the negative electrode tab 72 placed between the sealing portions. The sealing portion of the case 50 is made of a heat-melting material, and has a structure in which sealing is achieved by bonding heat-melting layers to each other. FIG. 2 is a diagram illustrating a cross section of a battery assembly of the pouch type secondary battery.

Referring to FIG. 2, a battery assembly 40 of the pouch type secondary battery may be formed by being wound in a jelly roll form. The battery assembly 40 may include a first electrode base 11, a first electrode mixture 12, a second electrode base 21, a second electrode mixture 22, a separator 30, a positive electrode tab 71, and a negative electrode tab 72. The first electrode base 11 and the first electrode mixture 12 may constitute the first electrode plate 10. The second electrode base 21 and the second electrode mixture 22 may constitute the second electrode plate 20.

The flatness of the battery assembly 40 is changed depending on a structure design of the battery assembly 40. In particular, as illustrated in FIG. 2, a thickness difference occurs between the electrode plate 10, 20 depending on a coating part/uncoated part of the electrode plate 10, 20 or a situation in which a tape is overlapped. As the thickness difference is increased, the adhesion of the separator at a corresponding portion is separated when compression at a high temperature is performed in a heater press charge (HPC) process. When the adhesion of the separator at a local location is separated, additional reactants are generated and accumulated when charging and discharging are performed. As the distance between pole plates is continuously increased, the lifespan of a battery is reduced and the thickness of the battery is increased due to precipitation and non-charging.

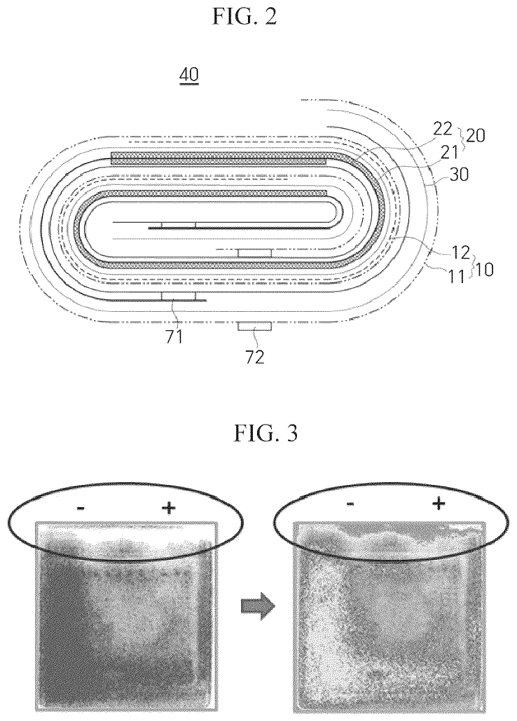

FIG. 3 is a view illustrating a thickness deviation according to a position of an electrode assembly.

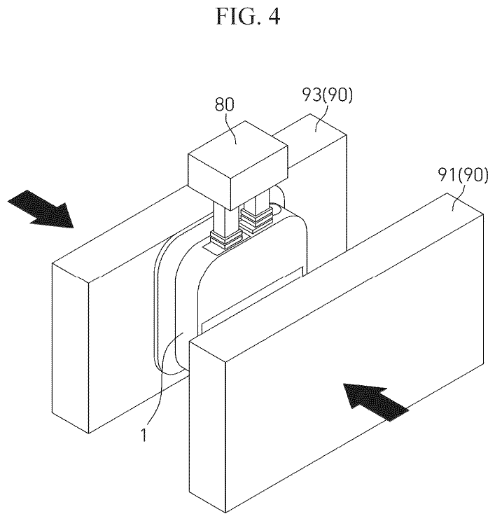

An electrode plate of the electrode assembly 40 may include a coated area in which an electrode material (such as a slurry) is applied to a substrate, and a non-coated portion (a non-coated area) formed on the substrate. Due to the characteristics of the process, the manufactured electrode plate may undergo non-uniformity in thickness depending on position on the electrode plate. In the case where the electrode assembly 40 is formed by stacking electrode plates and/or winding an electrode plate, the thickness deviation depending on position may be further increased. A shading difference in the drawing may indicate the thickness deviation of the electrode assembly 40 depending on position. More specifically, during a process of manufacturing the electrode plate, the electrode material that is in a slurry-state may be coated on the substrate to form the coated area. During the aforementioned process, due to the spreadability characteristics of the slurry, a coating layer may fail to have a uniform thickness on the substrate, and a thickness deviation depending on position may occur. The thickness deviation may prominently appear at a boundary between the coated area and the non-coated portion, the boundary being separately indicated in the drawing. Due to the thickness deviation of the electrode assembly 40 depending on position, the above-described problems, such as separation of a separator occurring at the corresponding position, during a high-temperature pressing process may occur more frequently. FIG. 4 is a view illustrating an example of a general heater press charge (HPC) process.

The HPC process may be a process of performing charging and discharging of a battery cell 1 under conditions required for activation through a charge/discharge component 80. The charging and discharging may be performed multiple times as needed. The HPC process may include a high-temperature pressing process. The pressing process may be a process of pressing the battery cell 1 to closely bond the electrode plates to each other and to allow an electrolyte to be uniformly impregnated between the electrode plates of the electrode assembly. By performing the process, lifting of the electrode plates may be suppressed, and the bonding force between the electrode plates may be enhanced.

A pressing apparatus 90 may include a first pressing plate 91 and a second pressing plate 93 that face each other. The first and second pressing plates 91 and 93 may function to press the battery cell 1 during the HPC process. For example, the pressing process may be a process of applying pressure to the battery cell 1 from opposite sides with the battery cell 1 interposed between the first and second pressing plates 91 and 93. The pressing process may be performed together with a heating process using a heating unit such as a heater.

A cushioning pad may be attached to or integrally formed on a pressing surface of each of the first and second pressing plates 91 and 93. The cushioning pad may be provided to prevent damage to the battery cell 1 due to pressure applied thereto during the pressing process, and to maintain flatness. The cushioning pad may be formed of silicone, Vulkollan, or the like.

The cushioning pad may receive a pressing force from the pressing plate and press the battery cell 1. However, as the cushioning pad that is secured to each of the first and second pressing plates 91 and 93 is used repeatedly in a plurality of HPC processes, permanent depression may occur at localized positions, and thus there may be a limitation in that the uniformity of pressure applied to the battery cell 1 may be reduced. In addition, there may be a limitation in overcoming the above-described issue of. thickness deviation depending on the position of the electrode assembly by using the cushioning pad.

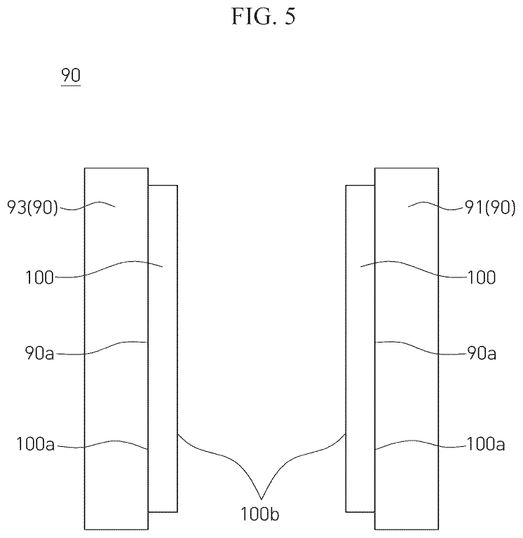

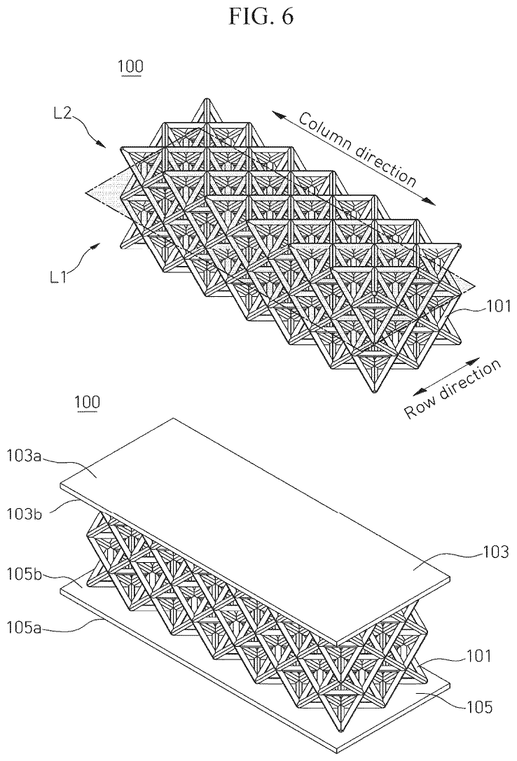

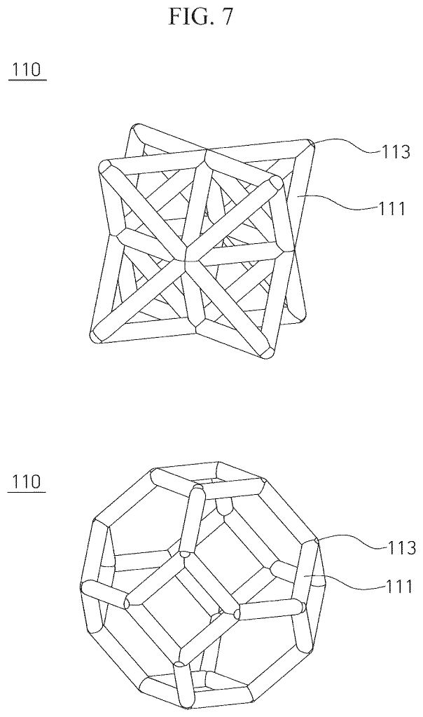

FIG. 5 is a schematic view illustrating a battery cell pressing apparatus according to embodiments of the present disclosure. FIG. 6 is a schematic view illustrating a pressing pad according to embodiments of the present disclosure. FIG. 7 is a view illustrating an example of a unit cell that forms the pressing pad according to embodiments of the present disclosure.

Referring to FIGS. 5 to 7, the battery cell pressing apparatus 90 according to embodiments of the present disclosure may include pressing plates 91 and 93 and a pressing pad 100. The pressing plates 91 and 93 may include a first pressing plate 91 and a second pressing plate 93, which are disposed to face each other with a battery cell interposed therebetween. The pressing plates 91 and 93 may be formed of a metallic material having low deformation in order to effectively transfer pressure to the battery cell. For example, the pressing plates 91 and 93 may be formed of an aluminum alloy, but are not limited thereto.

The pressing pad 100 may be fixed to a pressing surface 90a of each of the first and second pressing plates 91 and 93. Although not illustrated, each of the first and second pressing plates 91 and 93 and the pressing pad 100 may be fixed to each other by at least one fixing unit. For example, an adhesive layer may be interposed between each of the first and second pressing plates 91 and 93 and the pressing pad 100. The pressing pad 100 and each of the first and second pressing plates 91 and 93 may be fixed to each other through the adhesive layer. The pressing pad 100 may include a fixing surface 100a fixed to the pressing surface 90a of each of the first and second pressing plates 91 and 93, and a contact surface 100b that comes into contact with one surface of the battery cell and presses the battery cell.

The pressing pad 100 may include a three-dimensional lattice structure 101 provided by repeatedly or regularly arranging unit cells 110 formed by connecting struts 111 (or lattice pieces). The lattice structure 101 may be formed by repeatedly arranging identical unit cells, or by periodically arranging different unit cells in an alternating manner, One of various unit cells 110 capable of forming a three-dimensional lattice structure may be selected as the unit cell 110. The unit cell 110 may include a plurality of struts 111 and nodes 113 that connect the struts 111. The lattice structure may be effective in pressure distribution and shock absorption, and may have excellent resilience. Accordingly, compared to a structure using a conventional cushioning component, it may be possible to prevent permanent depression from occurring due to repeated exposure to HPC process situations. This may indicate that the pressing apparatus 90 has advantages in terms of maintenance, management, and repair.

The lattice structure 101 may include one or more layers L1 and L2 including a plurality of unit cells 110 arranged in a row direction and a column direction. The lattice structure 101 may be formed by stacking a plurality of layers L1 and L2 along a pressing direction. In at least one of the layers L1 and L2, or at a specific position, adjacent unit cells 110 may be connected to each other with at least one strut 111 and/or node 113 shared therebetween. Alternatively, in at least (of the layers L1 and L2, or at a specific position, adjacent unit cells 110 may also be simply fixed without sharing the strut 111 or the node 113.

In embodiments of the present disclosure, a reference size of the unit cell 110 may be defined as a size of a virtual unit hexahedron having preset width, length, and height. A size of each of the layers L1 and L2 may be defined as a size of a plurality of unit hexahedrons arranged in a row direction and a column direction. A size of the lattice structure 101 may be defined as a size of the stacked layers L1 and 12. In unit hexahedron, the density of the unit cell 110 may be determined by a porosity or a ratio of volume occupied by the struts 111. In order to control the relative density among the unit cells 110, the shape and size (or volume) of the unit cell 110 in the unit hexahedron, and the size {e.g., thickness (or diameter), and length} of each of the struts 111 constituting the unit cell 110 may be selectively varied. As needed, the densities of adjacent unit cells 110 may be different from each other. As needed, the densities of the unit cells 110 constituting the respective layers L1 and L2 may also be different from each other between the adjacent layers L1 and L2. As illustrated in FIG. 7, the unit cell 110 may be either an octet truss or a Kelvin cell, but is not limited thereto, and any known structure may be selected. For example, the unit cell 110 may be selected to have at least one topology among a Gibson-Ashby (GA), diamond, tetrahedral, pyramidal, Kagome, octahedron, and dodecahedron structure. Alternatively, the unit cell 110 may be selected to have at least one topology among a topology generated by a cubic primitive (CP), a body-centered cubic (BCC), a face-centered cubic (FCC), a combination of CP, BCC, and FCC (e.g., FBCC, FCCP, and BCCP), or a topology generated by adding struts to the aforementioned structures {e.g., BCCz, FCCz, FBCCz, and FBCCxyz (FBCCP)}. The unit cell 110 may be selected as one of a bending-dominant lattice structure (e.g., Kelvin, tetrahedral) and a stretching-dominant lattice Structure (e.g., octet truss, Kagome). The stretching-dominant lattice structure may undergo relatively uniform deformation across the entire structure when subjected to a load, compared to the bending-dominant lattice structure. Accordingly, it may be desirable that the unit cell 110 be selected as a stretching-dominant lattice structure.

The pressing pad 100 may include at least one of a first plate 103 fixed to one surface of the lattice structure 101, or a second plate 105 fixed to an additional surface of the lattice structure 101. The one surface of the lattice structure 101 may be a surface facing a surface of the pressing plate 91 or 93, and the additional surface may refer to a surface opposite to the one surface of the lattice structure 101 in the pressing direction. In embodiments, the pressing pad 100 may include both the first plate 103 and the second plate 105. The first plate 103 and the second plate 105 may be disposed to face each other in the pressing direction with the lattice structure 101 interposed therebetween. The first plate 103 and the second plate 105 may be integrally formed with the lattice structure 101. The first plate 103 may be fixed to the pressing surface 90a of the pressing plate 91 or 93. The first plate 103 may include a fixing surface 103a fixed to the pressing surface 90a of the pressing plate 91 or 93, and a connection surface 103b fixed to one surface of the lattice structure 101. The fixing surface 103a of the first plate 103 may be in surface-to-surface contact with the pressing surface 90a of the pressing plate 91 or 93, and may receive a pressing force from the pressing plate 91 or 93 and provide the pressing force to the lattice structure 101. Due to the first plate 103 further included in the pressing pad 100, the fixing between the pressing pad 100 and the pressing plate 91 or 93 may be facilitated.

The second plate 105 may come into contact with at least one surface of the battery cell during the pressing process, The second plate 105 may include a contact surface 105a that comes into contact with one surface of the battery cell and a connection surface 105b that is fixed to the additional surface of the lattice structure 101. The contact surface 105a of the second plate 105 may be in surface-to-surface contact with one surface of the battery cell, and may receive a pressing force from the lattice structure 101 and provide the pressing force to the battery cell. Due to the second plate 105 further included in the pressing pad 100, a more uniform pressing force may be provided to the battery cell. The pressing pad 100 may be fabricated through 3D printing. As a 3D printing method, selective laser sintering (SLS) may be used, but the 3D printing method is not limited thereto, and one of projection microstereolithography (PuSL), digital light processing (DLP), stereo lithography apparatus (SLA), self-propagating photopolymer waveguide (SPPW), fused deposition modeling {FDM, or fused filament fabrication (FFF)}, and binder jetting may also be used. The 3D printing method may be selected in consideration of factors such as the type and size of the target unit cell 110 and the thickness of the struts 111. Through 3D printing, the lattice structure 101, the first plate 103, and the second plate 105 may be integrally formed at the same time. A pressing structure 101 of the pressing pad 100 may be formed of synthetic resin. In embodiments, the pressing structure 101 may be formed of a thermoplastic polyurethane (TPU) material.

Hereinafter, the structure of the pressing pad for providing relatively uniform pressure to the battery cell accommodating the electrode assembly in response to a thickness deviation depending on position on the electrode assembly will be described.

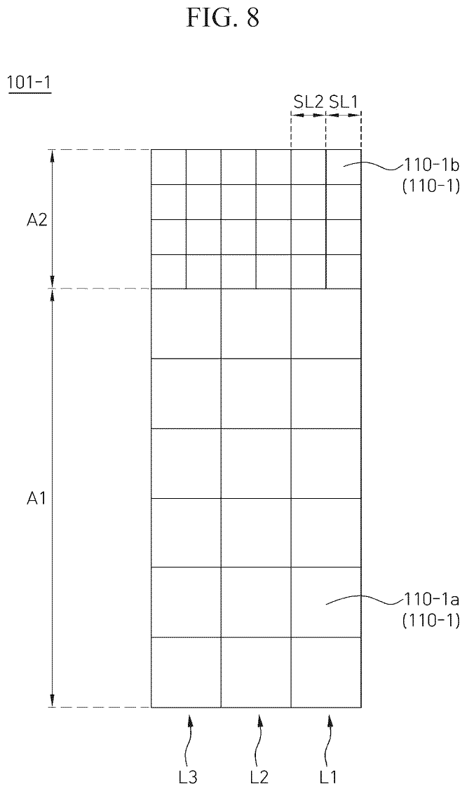

FIG. 8 is a schematic sectional view illustrating a lattice structure according to embodiments of the present disclosure. Referring to FIG. 8, a lattice structure 101-1 according to embodiments of the present disclosure may include a first area A1, and a second area A2 extending from the first area A1. The first area A1 and the second area A2 may be defined in a direction intersecting with the pressing direction. Alternatively, the first area A1 and the second area A2 may be defined in a direction corresponding to a longitudinal direction of the electrode assembly. As needed, the second area A2 may be defined as a plurality of areas. A first portion of the electrode assembly that is pressed through a contact surface corresponding to the first area A1 and a second portion of the electrode assembly that is pressed through a contact surface corresponding to the second area A2 may have different thicknesses. The second portion may include a portion having a smaller thickness than the first portion. In embodiments, the second portion may include a boundary between a coated area and a non-coated portion in which an electrode tab is formed.

The lattice structure 101-1 may include one or more layers L1, L2, and L3. In the drawing, an example in which the layers L1, L2, and L3 are configured as three layers is illustrated, but the present disclosure is not limited thereto. The layers L1, L2, and L3 may be stacked in the pressing direction and may be connected to each other. Each of the layers L1, L2, and L3 may include a plurality of unit cells 110-1 arranged in a row direction and a column direction.

The density of the unit cells 110-1 assigned to the first area A1 may be different from that of the unit cells 110-1 assigned to the second area A2. A higher density may indicate that compressive deformation may be reduced and that a relatively higher pressing force may be provided to a corresponding area. The density of the unit cells 110-1 assigned to the first area A1 may be lower than the density of the unit cells 110-1 assigned to the second area A2. Each of the unit cells 110-1 assigned to the first area A1 may be formed with the reference size (or volume). Each of the unit cells 110-1 assigned to the second area A2 may be formed to have a size smaller than the reference size. In other words, each of the unit cells 110-1 assigned to the first area A1 may be formed with the size of the unit hexahedron. Each of the unit cells 110-1 assigned to the second area A2 may be formed to have a size smaller than the size of the unit hexahedron. The foregoing may indicate that, within a space of the same size, a greater number of unit cells 110-1 may be arranged in the second area A2 compared to the first area A1.

More specifically, in the first area A1, the layers L1, L2, and L3 may include a plurality of first unit cells 110-1a arranged in a row direction and a column direction. In the second area A2, each of the layers L1, L2, and L3 may include sub-layers SL1 and SL2 obtained by dividing the corresponding layer L1, L2, or L3 into a plurality of layers. The sub-layers SL1 and SL2 may be stacked in the pressing direction and may be connected to each other. Each of the sub-layers SL1 and SL2 may include a plurality of second unit cells 110-1b arranged in the row direction and the column direction. In embodiments, the first unit cells 110-1a and the second unit cells 110-1b may be the same type of unit cell 110-1. The size of the second unit cell 110-1b may be set to be smaller than that of the first unit cell 110-1a. The size of the first unit cell 110-1a may correspond to the size of a virtual unit hexahedron, and the size of the second unit cell 110-1b may correspond to that of a virtual hexahedron that is smaller than the unit hexahedron. In the drawing, an example is illustrated in which each of the layers L1, L2, and L3 includes the sub-layers SL1 and SL2 in the second area A2, but the present disclosure is not limited thereto, and only one of the layers L1, L2, and L3 may selectively include the sub-layers SL1 and SL2,

The pressing pad 100 according to embodiments of the present disclosure may include a lattice structure 101-1 in which the first area A1 and the second area A2 having different densities are defined, and may provide different pressing forces corresponding to positions on the electrode assembly. In other words, the first portion of the electrode assembly having a relatively large thickness may be pressed through the pressing surface 90a of the first area A1 having a relatively low density, and the second portion of the electrode assembly having a relatively small thickness may be pressed through the pressing surface 90a of the second area A2 having a relatively high density. Accordingly, the electrode assembly having a thickness deviation may be uniformly pressed overall.

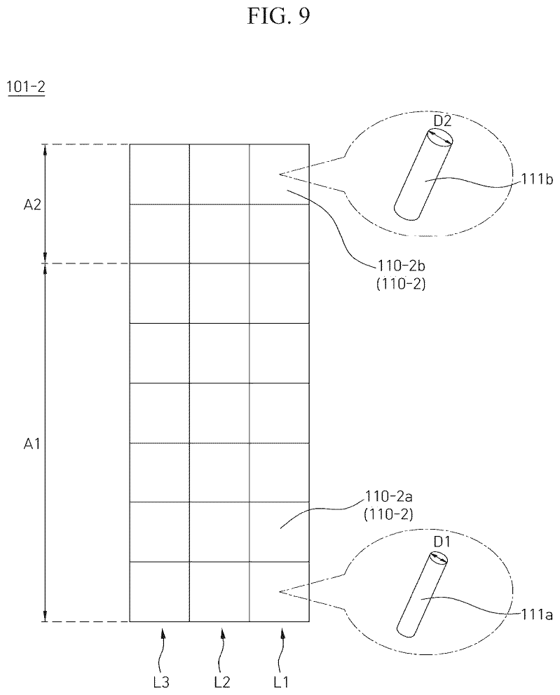

FIG. 9 is a schematic sectional view illustrating a pressing pad according to embodiments of the present disclosure. In the following description of embodiments of the present disclosure, descriptions of components that are substantially the same as those in the above-described embodiments will be omitted.

Referring to FIG. 9, the density of unit cells 110-2 assigned to the first area A1 may be different from that of the unit cells 110-2 assigned to the second area A2. A higher density may indicate that compressive deformation may be reduced and that a relatively higher pressing force may be provided to a corresponding area.

More specifically, each of the layers L1, L2, and L3 may include a plurality of unit cells 110-2 arranged in the row direction and the column direction. The unit cells 110-2 may include first unit cells 110-2a assigned to the first area A1 and second unit cells 110-2b assigned to the second area A2. In embodiments, the first unit cells 110-2a and the second unit cells 110-2b may be the same type of unit cell 110-2.

In the unit hexahedron, a porosity of the second unit cells 110-2b may be set lower than that of the first unit cells 110-2a. For example, a thickness D2 (or diameter) of struts 111b that form the second unit cells 110-2b may be set greater than a thickness D1 of struts 111a that form the first unit cells 110-2a. In the second area A2, all of the layers L1, L2, and L3 may include the second unit cells 110-2b, but the present disclosure is not limited thereto, and the second unit cells 110-2b may be selectively disposed only at specific positions in the second area A2.

The pressing pad 100 according to embodiments of the present disclosure may include a lattice structure 101-2 in which the first area A1 and the second area A2 having different densities are defined, and may provide different pressing forces corresponding to positions on the electrode assembly. In other words, the first portion of the electrode assembly having a relatively large thickness may be pressed through the contact surface of the first area A1 having a relatively low density, and the second portion of the electrode assembly having a relatively small thickness may be pressed through the contact surface of the second area A2 having a relatively high density. Accordingly, the electrode assembly having a thickness deviation may be uniformly pressed overall.

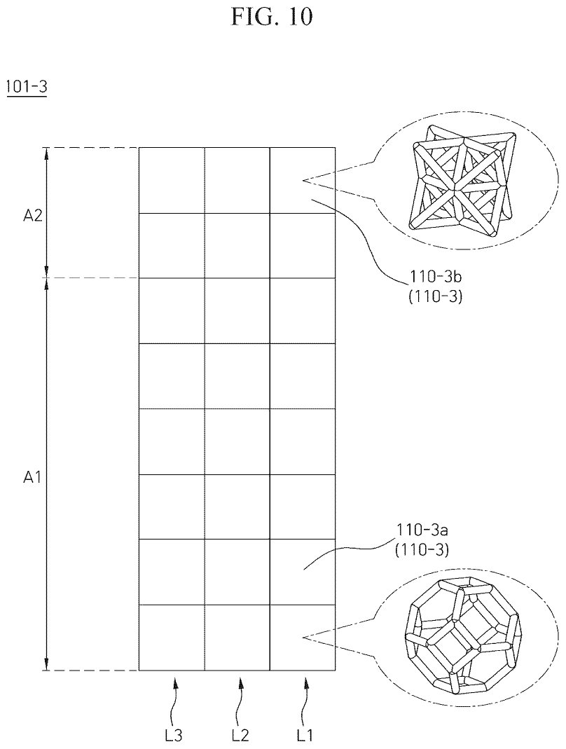

FIG. 10 is a schematic sectional view illustrating a pressing pad according to embodiments of the present disclosure. In the following description of embodiments of the present disclosure, descriptions of components that are substantially the same as those in the above-described embodiments will be omitted.

Referring to FIG. 10, the density of unit cells (110-3) assigned to the first area A1 may differ from that of unit cells (110-3) assigned to the second area A2. A higher density may indicate that compressive deformation may be reduced and that a relatively higher pressing force may be provided to a corresponding area.

More specifically, each of the layers L1, L2, and L3 may include a plurality of unit cells 110-3 arranged in a row direction and a column direction. The unit cells 110-3 may include first unit cells 110-3a assigned to the first area A1 and second unit cells 110-3b assigned to the second area A2. In embodiments, the first unit cells 110-3a and the second unit cells 110-3b may be different types of unit cell 110-3.

The second unit cell 110-3b may be configured to have a predetermined stiffness compared to the first unit cell 110-3a. The structures the first unit cell 110-3a and the second unit cell 110-3b may be selected in consideration of deformation resistance, energy absorption capability, and the like, under compression.

For example, the second unit cell 110-3b may be selected as one of structures classified as having relatively high stiffness (low deformation), such as an octet truss, Kagome, diamond cell, or FCC. The first unit cell 110-3a may be selected as one of structures classified as having relatively low stiffness (high deformation), such as a Kelvin, tetrahedral cell, or dodecahedron. For instance, the second unit cell 110-3b may be selected as a stretching-dominant type unit cell (e.g., an octet truss or Kagome) having relatively high stiffness (low deformation), and the first unit cell 110-3a may be selected as a bending-dominant type unit cell (e.g., a Kelvin or tetrahedral cell) having relatively low stiffness (high deformation).

The pressing pad 100 according to embodiments of the present disclosure may include a lattice structure 101-3 in which the first area A1 and the second area A2 having unit cells 110 with different structures are defined, and may provide different pressing forces corresponding to positions on the electrode assembly. In other words, the first portion of the electrode assembly having a relatively large thickness may be pressed through the contact surface of the first area A1 having a relatively low stiffness, and the second portion of the electrode assembly having a relatively small thickness may be pressed through the contact surface of the second area A2 having a relatively high stiffness. Accordingly, the electrode assembly having a thickness deviation may be uniformly pressed overall.

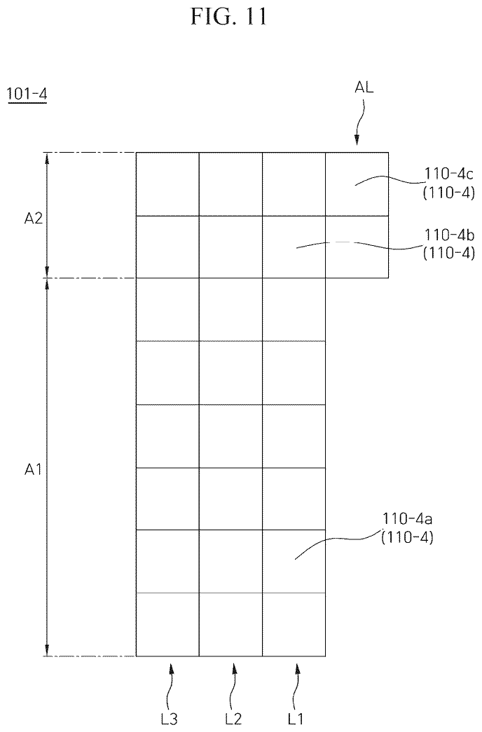

FIG. 11 is a schematic sectional view illustrating a pressing pad according to embodiments of the present disclosure. In the following description of embodiments of the present disclosure, descriptions of components that are substantially the same as those in the above-described embodiments will be omitted.

Referring to FIG. 11, a lattice structure 101-4 may include one or more layers L1, L2, and L3. In the drawing, an example in which the layers L1, L2, and L3 are configured as three layers is illustrated, but the present disclosure is not limited thereto. The layers L1, L2, and L3 may be stacked along the pressing direction and may be connected to each other. Each of the layers L1, L2, and L3 may include a plurality of unit cells 110-4 arranged in the row direction and the column direction.

The second area A2 may have a greater thickness than the first area A1. The foregoing may indicate that a contact surface corresponding to the second area A2 of the lattice structure 101-4 protrudes further along the pressing direction than a contact surface corresponding to the first area A1.

More specifically, the lattice structure 101-4 may include one or more additional layers AL that are selectively stacked only in the second area A2. As the additional layer AL is formed in the second area A2, the second area A2 of the lattice structure 101-4 may have a greater thickness than the first area A1. That is, the contact surface corresponding to the second area A2 of the lattice structure 101-4 may be positioned to protrude further along the pressing direction than the contact surface corresponding to the first area A1. During the pressing process, the contact surface corresponding to the second area A2 of the lattice structure 101-4 may come into contact with the battery cell earlier than the contact surface corresponding to the first area A1.

Each of the layers L1, L2, and L3 may include a plurality of unit cells 110-4 arranged in the row direction and the column direction. The unit cells 110-4 may include first unit cells 110-4a assigned to the first area Al and second unit cells 110-4b assigned to the second area A2. In embodiments, the first unit cells 110-4a and the second unit cells 110-4b may be the same type of unit cell 110-4.

The additional layer AL may be stacked along the pressing direction on the layers L1, L2, and L3 in the second area A2. The additional layer AL and the layers L1, L2, and L3 may be connected to each other. The additional layer AL may include a plurality of third unit cells 110-4c arranged in the row direction and the column direction. In embodiments, the third unit cells 110-4c may be the same type of unit cell 110-4 as the first unit cells 110-4a and the second unit cells 110-4b, but the present disclosure is not limited thereto.

The pressing pad 100 according to embodiments of the present disclosure may include the lattice structure 101-4 in which the first area A1 and the second area A2 having different thicknesses are defined, and may provide different pressing forces corresponding to positions on the electrode assembly. In other words, the first portion of the electrode assembly having a relatively large thickness may be pressed through the contact surface of the first area Al having a relatively small thickness, and the second portion of the electrode assembly having a relatively small thickness may be pressed through the contact surface of the second area A2 having a relatively large thickness. Accordingly, the electrode assembly having a thickness deviation may be uniformly pressed overall.

Hereinafter, materials which may be used in a secondary battery according to an embodiment of the present disclosure are described.

A compound (e. g., a lithiated intercalation compound) capable of reversible intercalation and deintercalation of lithium may be used as a positive electrode active material, Specifically, one type or more selected among complex oxides of metal, selected among cobalt, manganese, nickel, and a combination of them, and lithium may be used as the positive electrode active material.

The complex oxide may be lithium transition metal complex oxide. A detailed example of the complex oxide may include lithium nickel-based oxide, lithium cobalt-based oxide, lithium manganese-based oxide, a lithium ferrous phosphate-based compound, cobalt-free nickel-manganese-based oxide, or a combination of them.

For example, a compound that is represented as one of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤50.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001b≤0.1 ); LiₐCoG_{b}O₂(0.90a≤1.8, 0.001b≤0.1); LiₐMn_{1-b}GₚO₂ (0.90≤a≤1.8, 0.001≤b≤0.1); LiₐMn₂G_{b}O₄(0.90≤a≤1.8, 0.001≤b≤0.1); LiₐMn_{1-g}G_{g}PO₄ (0.90-a≤1.8, 0≤g≤0.5); Li_{(3-f)}Fe₂(PO₄)₃ (0≤f≤2); and LiₐFePO₄ (0.90≤a≤1.8).

In the chemical formula, A may be Ni, Co, Mn, or a combination of them. X may be Al, Ni, Co, Mn, Cr, Fe, Mg, Sr, V, a rare earth element, or a combination of them; D may be O, F, S, P, or a combination of them. G may be Al, Cr, Mn, Fe, Mg, La, Ce, Sr, V, or a combination of them. L1 may be Mn, Al, or a combination of them.

A positive electrode for lithium secondary battery may include a current collector and a positive electrode active material layer formed on the current collector. The positive electrode active material layer may include the positive electrode active material, and may further include a binder and/or a conductive material.

Content of the positive electrode active material may be 90 wt. % to 99.5 wt. & with respect to the positive electrode active material layer 100 wt. 8. Content of the binder and the conductive material may be 0.5 wt. % to 5 wt. % with respect to the positive electrode active material layer 100 wt. %. A1 may be used as the current collector, but the present disclosure may not be limited thereto.

A negative electrode active material may include a material capable of reversibly Intercalation/de-intercalation with respect to lithium ions, lithium metal, an alloy of lithium metal, a material capable of doping and dedoping with respect to lithium, or transition metal oxide.

The material capable of reversibly Intercalation/de-intercalation with respect to lithium ions may include a carbon-based negative electrode active material, for example, crystalline carbon, amorphous carbon, or a combination of them. An example of the crystalline carbon may include graphite, such as natural graphite or synthetic graphite. Examples of the amorphous carbon may include soft or hard carbon, mesophase pitch carbide, and fired coke.

An Si-based negative electrode active material or an Sn-based negative electrode active material may be used as the material capable of doping and dedoping with respect to lithium. The Si-based negative electrode active material may be silicon, a silicon-carbon composite, SiOₓ (0<x<2), a Si-based alloy, or a combination of them.

The silicon-carbon composite may be a composite of silicon and amorphous carbon. According to an implementation example, the silicon-carbon composite may include silicon particles, and may have a form in which amorphous carbon has been coated on surfaces of silicon particles.

The silicon-carbon composite may further include crystalline carbon. For example, the silicon-carbon composite may include a core including crystalline carbon and silicon particles, and an amorphous carbon coating layer disposed on a surface of the core.

A negative electrode for a lithium secondary battery may include a current collector and a negative electrode active material layer disposed on the current collector. The negative electrode active material layer may include the negative electrode active material, and may further include a binder and/or a conductive material.

For example the negative electrode active material layer may include the negative electrode active material of 90 wt. % to 99 wt. %, the binder of 0.5 wt. % to 5 wt. %, and the conductive material of 0 wt. & to 5 wt. %.

A nonaqueous-based binder, a aqueous-based binder, a dry binder, or a combination of them may be used as the binder. If the aqueous-based binder is used as a binder for the negative electrode, the binder for the negative electrode may further include a cellulose-series compound capable of assigning viscosity.

One selected among nickel foil, stainless steel foil, titanium foil, nickel foam, copper foam, a polymer base on which a conductive metal has been coated, and a combination of them may be used as a current collector for the negative electrode.

An electrolyte for a lithium secondary battery may include a nonaqueous organic solvent and lithium salts.

The nonaqueous organic solvent may play a role as a medium through which ions that are involved in an electrochemical reaction of a battery can move.

The nonaqueous organic solvent may be a carbonate-based, ester-based, ether-based, ketone-based, or alcohol-based solvent, an aprotic solvent, or a combination of them. The carbonate-based, ester-based, ether-based, ketone-based, or alcohol-based solvent, or the aprotic solvent may be used solely, or two types or more of them may be mixed and used as the nonaqueous organic solvent.

Furthermore, if the carbonate-based solvent is used, annular carbonate and chain carbonate may be mixed and used.

A separator may be present between the positive electrode and the negative electrode depending on the type of lithium secondary battery. Polyethylene, polypropylene, and polyvinylidene fluoride, or a multi-layer having two or more layers of them may be used as the separator.

The separator may include a porous base, and a coating layer including an organic matter, an inorganic matter, or a combination of them that is disposed on one or both sides of the porous base.

The organic matter may include a polyvinylidene fluoride-based heavy antibody or (meth) acrylic polymer.

The inorganic matter may include inorganic particles selected among Al₂O₃, SiO₂, TiO₂, SnO₂, CeO₂, MgO, NiO, CaO, GaO, ZnO, ZrO₂, Y₂O₃, SrTiO₃, BaTiO₃, Mg (OH)₂, boehmite, and a combination of them, but the present disclosure is not limited thereto.

The organic matter and the inorganic matter may have a form in which the organic matter and the inorganic matter have been mixed in one coating layer or a form in which a coating layer including the organic matter and a coating layer including the inorganic matter have been stacked.

Although the present disclosure has been described above in connection with the limited embodiments and drawings, the present disclosure is not limited to the embodiments. A person having ordinary knowledge in the art to which the present disclosure pertains may modify and change the present disclosure within the technical spirit of the present disclosure and the equivalent range of the following claims.

What is claimed is:

1. A pressing apparatus for manufacturing a secondary battery, the pressing apparatus comprising:
a pressing plate; and
a pressing pad secured to a pressing surface of the pressing plate, and including a three-dimensional lattice structure provided by repeatedly or regularly arranging unit cells each formed by connecting struts.

2. The pressing apparatus as claimed in claim 1, wherein the lattice structure includes at least one layer including the plurality of unit cells arranged in a column direction and a row direction, and includes a first area and a second area extending from the first area, the first area and the second area being defined in a direction intersecting with a pressing direction.

3. The pressing apparatus as claimed in claim 2, wherein a density of the unit cells assigned to the second area is higher than a density of the unit cells assigned to the first area.

4. The pressing apparatus as claimed in claim 2, wherein a size of each of the unit cells assigned to the second area is less than a size of each of the unit cells assigned to the first area.

5. The pressing apparatus as claimed in claim 2,
wherein the at least one layer includes a plurality of sub-layers divided along the pressing direction in correspondence with the second area,
wherein the at least one layer in the first area includes a first unit cell,
wherein each of the sub-layers in the second area includes a second unit cell, and
wherein a size of the second unit cell is less than a size of the first unit cell.

6. The pressing apparatus as claimed in claim 5, wherein the first unit cell and the second unit cell are configured as respective unit cells having a same structure.

7. The pressing apparatus as claimed in claim 2, wherein a porosity of the unit cells assigned to the second area is set lower than a porosity of the unit cells assigned to the first area.

8. The pressing apparatus as claimed in claim 2, wherein a thickness of each of the struts that form the unit cells assigned to the second area is set greater than a thickness of each of the e struts that form the unit cells assigned to the first area.

9. The pressing apparatus as claimed in claim 2,
wherein the unit cells comprise a first unit cell assigned to the first area, and a second unit cell assigned to the second area,
wherein the second unit cell has a structure different from a structure of the first unit cell.

10. The pressing apparatus as claimed in claim 9, wherein the second unit cell is selected as including a structure having a higher stiffness or lower strain than a stiffness or strain of a structure of the first unit cell.

11. The pressing apparatus as claimed in claim 10,
wherein the second unit cell is selected as one of an octet truss, Kagome, diamond cell, or face-centered cubic (FCC), and
wherein the first unit cell is selected as one of a Kelvin cell, tetrahedral cell, or dodecahedron.

12. The pressing apparatus as claimed in claim 10,
wherein the second unit cell is selected as one of unit cells having a stretching-dominant structure, and
wherein the first unit cell is selected as one of unit cells having a bending-dominant structure.

13. The pressing apparatus as claimed in claim 2, wherein the second area has a greater thickness than a thickness of the first area.

14. The pressing apparatus as claimed in claim 13, wherein the second area further includes an additional layer stacked on the at least one layer along the pressing direction, the additional layer including a plurality of unit cells arranged in the column direction and the row direction.

15. The pressing apparatus as claimed in claim 1, wherein the pressing pad comprises
a first plate including a fixing surface fixed to the pressing surface of the pressing plate, and a connection surface fixed to one surface of the lattice structure.

16. The pressing apparatus as claimed in claim 15, wherein the pressing pad comprises
a second plate disposed to face the first plate along the pressing direction with the lattice structure interposed therebetween, the second plate including a connection surface fixed to another surface of the lattice structure.

17. The pressing apparatus as claimed in claim 16, wherein the first plate and the second plate are integrally formed with the lattice structure.

18. The pressing apparatus as claimed in claim 16, wherein the first plate and the second plate are formed of a same material as a material of the lattice structure.

19. The pressing apparatus as claimed in claim 18, wherein the pressing pad is formed of thermoplastic polyurethane (TPU).

20. The pressing apparatus as claimed in claim 1, wherein each of the unit cells is selected as one of unit cells having a stretching-dominant lattice structure.
